(19) United States
(12) Patent Application Publication
(10) Pub. No.: US 2022/0403626 A1
(43) Pub. Date: Dec. 22, 2022

(54) WORK VEHICLE DISPLAY CONTROL DEVICE AND WORK VEHICLE

(71) Applicant: Komatsu Ltd., Tokyo (JP)

(72) Inventor: Makoto Nomura, Tokyo (JP)

(73) Assignee: Komatsu Ltd., Tokyo (JP)

(21) Appl. No.: 17/777,229

(22) PCT Filed: Jan. 19, 2021
(86) PCT No.: PCT/JP2021/001596

§ 371 Date: May 16, 2022

(30) Foreign Application Priority Data
Jan. 31, 2020 (JP) 2020-015816

(51) Int. Cl. E02F 9/26; B60K 35/00; B60L 58/10

(52) U.S. Cl. CPC E02F 9/26; B60K 35/00; B60L 58/10; B60L 2200/40; B60L 2240/545; B60L 2240/547; B60L 2240/549; E02F 9/2228

(57) ABSTRACT

A display unit controller of a work vehicle includes a plurality of high-voltage charging systems, at least one of working equipment or a traveling device being driven by an electric motor, the display unit controller including: a charging/operation determination unit that functions as a detection unit detecting an abnormality for each of the charging systems and functions as a determination unit determining availability of work or traveling of the work vehicle; and a display control unit varying a charging availability indication indicating presence or absence of the abnormality for each of the charging systems according to the presence or absence of the abnormality for each of the charging systems based on a detection result of the detection unit, and varying an operation availability indication indicating availability of work or traveling according to the availability of work or traveling based on a determination result of the determination unit.

### FIELD

The present disclosure relates to a work vehicle display control device and a work vehicle.

### BACKGROUND

For example, some work vehicles such as excavators are driven by power supplied from rechargeable batteries. There is known a battery-driven construction machine that charges batteries with a plurality of charging systems (see, for example, Patent Literature 1.). There is known a hybrid working equipment that determines a state of a device such as an engine and displays malfunction on an energy display screen when the malfunction is determined (see, for example, Patent Literature 2.).

### CITATION LIST

### Patent Literature

Patent Literature 1: JP 2009-084838 A
Patent Literature 2: JP 2015-017437 A

### SUMMARY

### Technical Problem

A work vehicle having a plurality of high-voltage charging systems can be charged in other charging systems that do not hinder charging even if an abnormality that hinders the charging occurs in some of the charging systems. However, when an abnormality that hinders the charging occurs in some of the charging systems, a conventional work vehicle often displays only “there is an abnormality in a high-voltage system”, and thus it is difficult for the operator to appropriately recognize the influence range of the failure. Therefore, there is a possibility that the operator cannot determine that charging can be performed by other charging systems that do not hinder charging, and stops the operation of the work vehicle.

An object of the present disclosure is to provide a work vehicle display control device and a work vehicle capable of displaying the availability of charging for each charging system and the availability of work or traveling.

### Solution to Problem

According to an aspect of the present invention, a work vehicle display control device of a work vehicle including a plurality of high-voltage charging systems, at least one of working equipment and a traveling device being driven by a driving force of an electric motor, the work vehicle display control device comprising: a detection unit that detects an abnormality for each of the charging systems; a determination unit that determines availability of work or traveling of the work vehicle; and a display control unit that varies a charging availability indication indicating presence or absence of the abnormality for each of the charging systems according to the presence or absence of the abnormality for each of the charging systems based on a detection result of the detection unit, and varies an operation availability indication indicating availability of work or traveling according to the availability of work or traveling based on a determination result of the determination unit.

According to another aspect of the present invention, a work vehicle comprises: a display unit of a work vehicle that is rechargeable; and the work vehicle display control device.

### Advantageous Effects of Invention

According to the present disclosure, it is possible to display the availability of charging for each charging system and the availability of work or traveling.

### BRIEF DESCRIPTION OF DRAWINGS

FIG. 1 is a perspective view illustrating a work vehicle according to a present embodiment.

FIG. 2 is a block diagram illustrating a system configuration of the work vehicle.

FIG. 3 is a schematic diagram illustrating an example of a display device of the work vehicle.

FIG. 4 is a block diagram illustrating a work vehicle display control device of the work vehicle.

FIG. 5 is a flowchart illustrating a processing procedure of a display unit controller.

FIG. 6 is a block diagram illustrating a computer system according to the present embodiment.

FIG. 7 is a schematic diagram illustrating another example of the display device of the work vehicle.

FIG. 8 is a diagram for describing an example of a display related to a normal charging system.

FIG. 9 is a diagram for describing an example of a display related to a quick charging systems.

FIG. 10 is a diagram for describing an example of a display related to an operation of an electric motor.

FIG. 11 is a diagram for describing another example of the display related to the normal charging system.

FIG. 12 is a diagram for describing another example of the display related to the quick charging system.

FIG. 13 is a diagram for describing another example of the display related to the normal charging system.

FIG. 14 is a diagram for describing another example of the display related to the quick charging system.

### DESCRIPTION OF EMBODIMENTS

Hereinafter, embodiments of the present invention will be described with reference to the accompanying drawings, but the present disclosure is not limited thereto. The components of the embodiments described below can be appropriately combined. In addition, some components may not be used.

[Work Vehicle]

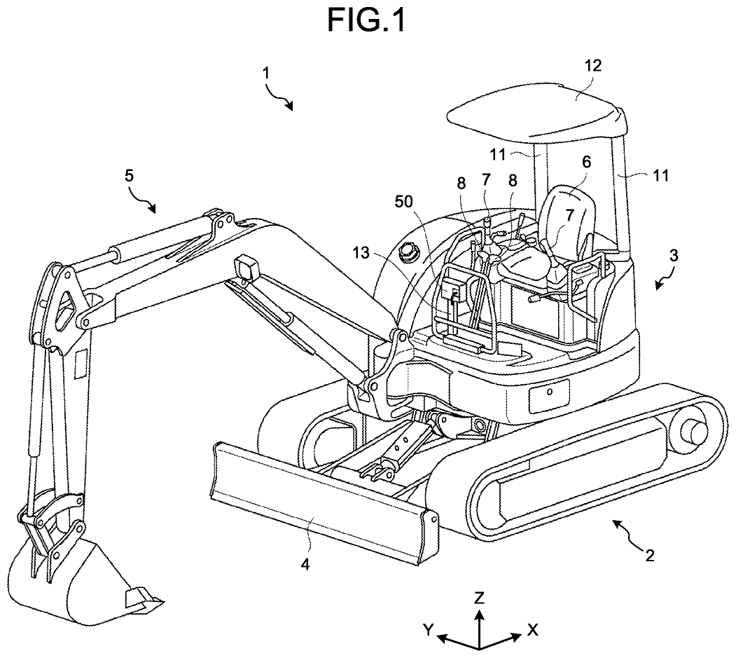

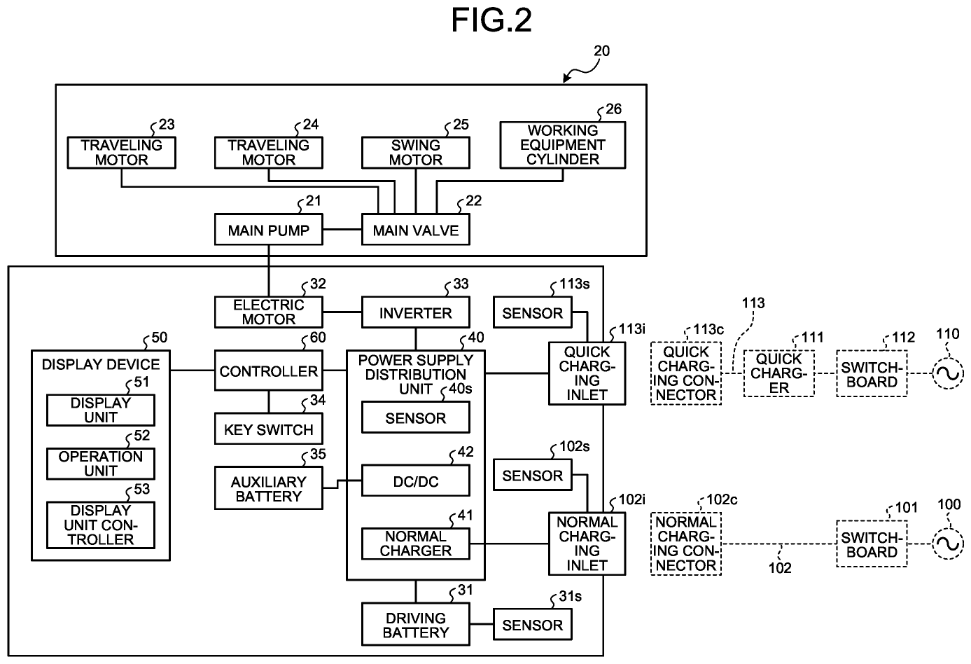

FIG. 1 is a perspective view illustrating a work vehicle 1 according to a present embodiment. FIG. 2 is a block diagram illustrating a system configuration of the work vehicle 1. The work vehicle 1 includes a storage battery, for example, a driving battery 31, which is a rechargeable power storage device, and is driven by power supplied from the driving battery 31. The work vehicle 1 is driven by a hydraulic system 20 driven by an electric motor 32. The work vehicle 1 includes a plurality of high-voltage charging systems. In the present embodiment, a quick charging system and a normal charging system are included as the plurality of high-voltage charging systems. In the present embodiment, the work vehicle 1 is a small excavator. In the following description, the work vehicle 1 is appropriately referred to as an excavator 1. The work vehicle 1 is a rechargeable work vehicle.

The excavator 1 includes a lower traveling body 2 including crawler belts, an upper swing body 3, a blade 4, and working equipment 5. The upper swing body 3 is disposed so as to be capable of swinging on the upper side of the lower traveling body 2. The blade 4 is disposed on the front side of the lower traveling body 2 so as to be capable of performing a lift operation. The blade 4 can perform the lift operation by hydraulic actuators. The working equipment 5 is disposed on the front side of the upper swing body 3. The working equipment 5 includes a boom, an arm, and a bucket. The working equipment 5 performs excavation work and the like by driving the boom, the arm, and the bucket by individual hydraulic actuators. Note that an excavator having no blade may be used.

An operator seat 6, working equipment levers 7, traveling levers 8, and a boom swing operation pedal (not illustrated) are disposed on the upper swing body 3. The working equipment levers 7 are disposed on the left side and the right side of the operator seat 6. A pair of traveling levers 8 and a boom swing operation pedal are disposed on the front side of the operator seat 6. Note that an excavator without boom swing or an operation pedal may be used.

The excavator 1 is, for example, a canopy specification. A roof 12 supported by two pillars 11 erected on the upper swing body 3 is disposed on the upper side of the operator seat 6. A display device 50 supported by a support arm 13 erected on the floor is disposed on a side of the traveling levers 8. The display device 50 may be disposed in a console on the right side of the operator seat 6. The display device 50 is provided within a range visually recognizable by the operator. The display device 50 will be described later.

[Hydraulic System of Work Vehicle]

The excavator 1 includes the hydraulic system 20 that drives the excavator 1. The hydraulic system 20 drives the lower traveling body 2, the upper swing body 3, and the working equipment 5. The hydraulic system 20 includes a main pump 21 driven by a driving force generated by the electric motor 32 provided in the upper swing body 3, a main valve 22 connected to the main pump 21 via a flow path, a swing motor 25 and a working equipment cylinder 26 driven based on hydraulic oil supplied from the main pump 21, and a traveling motor 23 and a traveling motor 24 provided in the lower traveling body 2. The excavator according to the present embodiment is an electric excavator that drives the working equipment by driving the hydraulic system with the electric motor.

The main pump 21 is a power source for the traveling motor 23, the traveling motor 24, the swing motor 25, and the working equipment cylinder 26. The main pump 21 is connected to an output shaft of the electric motor 32 and operates by a driving force generated by the electric motor 32.

The traveling motor 23 and the traveling motor 24 are motors for causing the excavator 1 to travel. The traveling motor 23 operates one crawler belt of the lower traveling body 2. The traveling motor 24 operates the other crawler belt of the lower traveling body 2. When the traveling motor 23 and the traveling motor 24 are driven, the excavator 1 travels.

The swing motor 25 is a motor for swinging the upper swing body 3. When the swing motor 25 is driven, the upper swing body 3 swings.

The working equipment cylinder 26 is a hydraulic cylinder for operating the working equipment 5. The working equipment cylinder 26 extends and contracts based on the flow rate of the hydraulic oil. When the working equipment cylinder 26 extends or contracts, the working equipment 5 operates.

[Electrical System of Work Vehicle]

The electric motor 32 is driven by power supplied from the driving battery 31. The lower traveling body 2, the upper swing body 3, and the working equipment 5 are driven via the hydraulic system 20. The hydraulic excavator 1 includes the driving battery 31, the electric motor 32, an inverter 33 that supplies power to the electric motor 32, an auxiliary battery 35 of 12 V or 24 V that supplies power to a power supply distribution unit 40, a controller 60, the display device 50, and the inverter 33, and the power supply distribution unit 40, in the upper swing body 3.

The driving battery 31 supplies power required for driving the excavator 1. That is, the driving battery 31 is a high-voltage driving battery. The driving battery 31 has a higher voltage than the voltage of the auxiliary battery 35. The driving battery 31 can be repeatedly charged, and is charged at night, for example. Charging and discharging of the driving battery 31 are controlled by the power supply distribution unit 40.

A sensor 31s is disposed in the driving battery 31. The sensor 31s detects the temperature, voltage, and current of the driving battery 31. The sensor 31s can detect battery information that is information on the driving battery 31 in an operation mode, a normal charging mode, or a quick charging mode. The sensor 31s outputs detected battery information on the temperature, voltage, and current of the driving battery 31 to the controller 60.

The electric motor 32 generates a driving force for driving the main pump 21. The electric motor 32 is driven by power output from the inverter 33. The main pump 21 is connected to the output shaft of the electric motor 32.

A sensor (not illustrated) is installed in the electric motor 32. The sensor outputs detected information on the discharge system such as the temperature, voltage, current, and engine speed of the electric motor 32 to the controller 60. The information on the discharge system is information related to performing discharging.

The inverter 33 converts a DC voltage output from the driving battery 31 into an AC voltage via the power supply distribution unit 40 and outputs the AC voltage to the electric motor 32.

A sensor (not illustrated) is installed in the inverter 33. The sensor outputs detected discharge system information such as the temperature, voltage, and current of the inverter 33 to the controller 60.

The power supply distribution unit 40 includes a switch such as a contactor (not illustrated). The power supply distribution unit 40 opens and closes the contactor in accordance with a control signal from the controller 60, and controls switching of high-voltage circuits for charging and discharging the driving battery 31. The power supply distribution unit 40 includes a charging circuit that charges the driving battery 31 and a high-voltage circuit that supplies power output from the driving battery 31 to the inverter 33. The charging circuit includes a quick charging high-voltage circuit that performs quick charging in a quick charging mode and a normal charging high-voltage circuit that performs normal charging in a normal charging mode.

In the quick charging mode, the power supply distribution unit 40 forms a high-voltage circuit such that power can be supplied from a quick charger 111 to the driving battery 31 to quickly charge the driving battery 31. In the power supply distribution unit 40, a quick charging contactor that opens and closes the quick charging high-voltage circuit is disposed between a quick charging inlet 113i and the driving battery 31. When the driving battery 31 is quickly charged, the quick charging contactor is brought into a conductive state (closed state or ON state) by the controller 60. When the driving battery 31 is not quickly charged, a quick charging contactor 66 is brought into a non-conductive state (open state or OFF state) by the controller 60.

In the normal charging mode, the power supply distribution unit 40 form a high-voltage circuit such that power can be supplied from a commercial power source 100 to the driving battery 31 via a normal charger 41 to normally charge the driving battery 31. In the power supply distribution unit 40, a normal charging contactor that opens and closes a normal charging high-voltage circuit is disposed between a normal charging inlet 102i and the driving battery 31. When the driving battery 31 is normally charged, the normal charging contactor is brought into a conductive state by the controller 60. When the driving battery 31 is not normally charged, the normal charging contactor 66 is brought into a non-conductive state by the controller 60.

In the operation mode, the power supply distribution unit 40 supplies power from the driving battery 31 to the electric motor 32 via the inverter 33. In the power supply distribution unit 40, a discharging contactor that opens and closes a discharging high-voltage circuit is disposed between the driving battery 31 and the inverter 33. When the driving battery 31 is discharged, the discharging contactor is brought into a conductive state by the controller 60. When the driving battery 31 is not discharged, the discharging contactor 66 is brought into a non-conductive state by the controller 60.

Various sensors 40s are disposed in the power supply distribution unit 40. A sensor 40s includes an open/close sensor that detects an open/close state of a contactor, a voltage sensor that detects a voltage, and a current sensor that detects a current in each of the quick charging high-voltage circuit, the normal charging high-voltage circuit, and the discharging high-voltage circuit.

The sensor 40s detects the state of the high-voltage circuit of the quick charging system by monitoring the open/close state, the voltage, and the current of the contactor as the switch in the quick charging high-voltage circuit. The sensor 40s outputs detected information on the high-voltage circuit of the quick charging system to the controller 60.

The sensor 40s detects the state of the high-voltage circuit of the normal charging system by monitoring the open/close state, the voltage, and the current of the contactor as the switch in the normal charging high-voltage circuit. The sensor 40s outputs detected information on the high-voltage circuit of the normal charging system to the controller 60.

The sensor 40s detects the state of the high-voltage circuit of the discharge system by monitoring the open/close state, the voltage, and the current of the contactor as the switch in the discharging high-voltage circuit. The sensor 40s outputs detected information on the high-voltage circuit of the discharge system to the controller 60.

The controller 60 includes an input unit 601 that receives a signal from a sensor or the like, a charging/operation determination unit 602, an output unit 603, and a storage unit 604. Signals from the sensor 40s, a sensor 113s, a sensor 102s, the normal charger 41, the quick charger 111, and the like are input to the input unit 601. The charging/operation determination unit 602, the output unit 603, and the storage unit 604 will be described later.

[Charging of Work Vehicle]

The excavator 1 has a plurality of high-voltage charging systems. In the present embodiment, the excavator 1 includes the normal charging system and the quick charging system. More specifically, the excavator 1 can perform the normal charging by a charger, for example, the normal charger 41, which is a charging unit mounted in the vehicle body, and the quick charging by the quick charger 111 installed outside the vehicle. Note that the normal charger 41 may be provided outside the vehicle, or the quick charger 111 may be provided inside the vehicle.

The normal charger 41 normally charges the driving battery 31. The normal charger 41 is included in the power supply distribution unit 40. Note that the normal charger 41 may not be included in the power supply distribution unit 40, and may be provided in the vehicle. In addition, the normal charger 41 may be provided outside the vehicle. When a normal charging connector 102c of a normal charging cable 102 is connected to the normal charging inlet 102i, the normal charger 41 is connected to a switchboard 101 and the commercial power source 100. The switchboard 101 distributes the single-phase 200 V power input from the commercial power source 100, and supplies part of the power to the normal charger 41 via the normal charging cable 102. The normal charger 41 converts the input single-phase 200 V AC power into DC power suitable for charging the driving battery 31. The normal charger 41 charges the driving battery 31.

A sensor (not illustrated) is installed in the normal charger 41. The normal charger 41 outputs, to the controller 60, information on the normal charging system, which is information related to performing the normal charging, such as the temperature, voltage, and current of the normal charger 41 detected by the sensor.

The sensor 102s is connected to the normal charging inlet 102i. The sensor 102s detects whether the normal charging connector 102c of the normal charging cable 102 is connected to the normal charging inlet 102i. The sensor 102s detects information for monitoring the state of the presence or absence of abnormality of the normal charging system and the presence or absence of power supply by monitoring the voltage and the current in the normal charging inlet 102i. The sensor 102s includes a voltage sensor that detects a voltage and a current sensor that detects a current. The sensor 102s may include a temperature sensor that detects a temperature, and in this case, detects a temperature at the normal charging inlet 102i. The sensor 102s outputs detected information on the normal charging system to the controller 60.

The quick charger 111 quickly charges the driving battery 31. The quick charger 111 includes an operation switch (not illustrated) that receives, for example, a start operation and a stop operation of the quick charging. The quick charger 111 is connected to a switchboard 112 and a commercial power source 110. The switchboard 112 supplies the three-phase 200 V power input from the commercial power source 110 to the quick charger 111. In a state where a quick charging connector 113c of a quick charging cable 113 is connected to the quick charging inlet 113i of the excavator 1, when receiving a start operation of quick charging, the quick charger 111 converts the input three-phase 200 V AC power into DC power suitable for quick charging and supplies the converted DC power. The quick charger 111 charges the driving battery 31.

The sensor 113s is connected to the quick charging inlet 113i. The sensor 113s detects whether the quick charging connector 113c of the quick charging cable 113 is connected to the quick charging inlet 113i. The sensor 113s detects information for monitoring the state of the presence or absence of abnormality of the quick charging system and the presence or absence of power supply by monitoring the voltage and the current in the quick charging inlet 113i. The sensor 113s includes a voltage sensor that detects a voltage and a current sensor that detects a current. The sensor 113s may have a temperature sensor that detects a temperature, and in this case, detects a temperature at the quick charging inlet 113i. The sensor 113s outputs detected information on the quick charging system to the controller 60. The information on the quick charging system is information related to performing the quick charging.

[Control System of Work Vehicle During Normal Charging]

When detecting that the normal charging connector 102c of the normal charging cable 102 is connected to the normal charging inlet 102i connected to the normal charger 41, the controller 60 enters the normal charging mode, and activates the normal charger 41 to start the normal charging from the normal charger 41 to the driving battery 31. Note that the normal charging may be started by an operator operating a switch (not illustrated). The controller 60 stops the charging when the normal charging connector 102c of the normal charging cable 102 is removed from the normal charging inlet 102i, or when the driving battery 31 is charged to a predetermined amount, for example, when it is detected that the battery is fully charged or an abnormality occurs during charging, or when charging is turned off by an operator, or the like. Note that charging may be stopped when a predetermined charging time is completed.

[Control System of Work Vehicle During Quick Charging]

For example, when detecting that a start operation of the quick charging is received in a state where the quick charging connector 113c of the quick charging cable 113 is connected to the quick charging inlet 113i of the excavator 1, the controller 60 enters the quick charging mode and starts the quick charging from the quick charger 111 to the driving battery 31. The controller 60 stops the quick charging when receiving a stop operation of quick charging, when a predetermined charging time is completed, or when an abnormality is detected during charging. Alternatively, the charging may be stopped when the driving battery 31 is charged to a predetermined amount, for example, when the driving battery is fully charged. In addition, the controller 60 may stop charging by receiving a charge stop command from the quick charger 111 via the quick charging cable 113 via communication or a signal line.

[Control System of Work Vehicle]

The excavator 1 is controlled by the controller 60. A key switch 34, the power supply distribution unit 40, and the display device 50 are connected to the controller 60. When the key switch 34 is keyed ON (energized) in a state where the quick charging connector 113c and the normal charging connector 102c are not connected, the excavator 1 is activated in the operation mode. An operation amount is input to the controller 60 from, for example, the working equipment lever 7 or the traveling lever 8. The controller 60 is connected with a plurality of sensors that detect, for example, the value of current flowing through the electric motor 32, the voltage and temperature of the driving battery 31, the temperature of hydraulic oil, and the like. The controller 60 drives and controls the main pump 21 of the hydraulic pump by operating the electric motor 32 via the power supply distribution unit 40 based on an operation amount of an operation lever such as the working equipment lever 7 or the traveling lever 8, a detection value detected by a sensor, and the like. The hydraulic pressure from the main pump 21 causes the lower traveling body 2 to travel, the upper swing body 3 to swing, and the working equipment 5 and the like to operate according to the operation amount of each operation lever. Note that each operation lever may be an electric operation lever that outputs an operation amount by an electric signal, or may be a hydraulic operation lever. Note that, in the hydraulic operation lever, a valve may be driven according to an operation to supply oil from the main pump 21 to the traveling motor 23, the traveling motor 24, the swing motor 25, and the working equipment cylinder 26.

[Display Device of Work Vehicle]

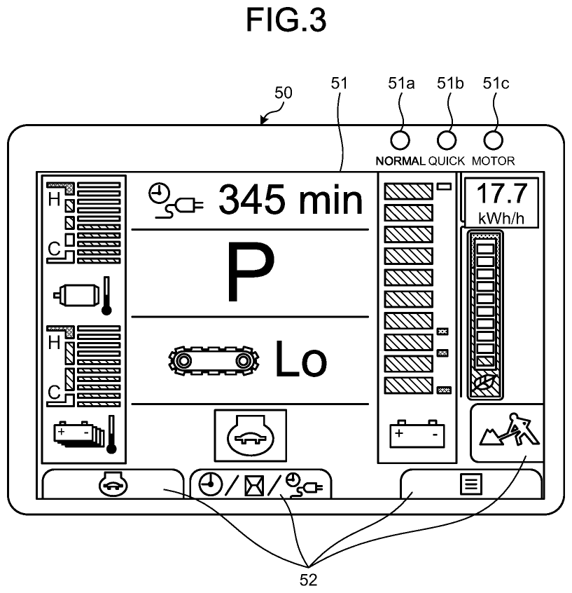

FIG. 3 is a schematic diagram illustrating an example of the display device 50 of the excavator 1. The display device 50 is implemented by using an organic EL, a liquid crystal display screen, or the like. The display device 50 includes a display unit 51 as a display screen that displays various types of information including operation information that is information displayed on a monitor during operation of the excavator 1, an operation unit 52 to which various instructions or information are input by an operator, and a display unit controller 53 that is implemented by using a CPU or the like and controls the display device 50. When the controller 60 is in the operation mode, the normal charging mode, or the quick charging mode, power is supplied from the auxiliary battery 35 to the display device 50. Note that the operation unit 52 may be provided at a location different from the display device 50 like a console, and the display unit controller 53 may be provided at a location different from the display device 50 like the controller 60 or the like.

When the excavator 1 is in the operation mode, the backlight is always turned on, and the display unit 51 displays the operation information. The operation information is, for example, a service meter indicating an accumulated operation time, a temperature of the driving battery 31 in the operation information related to the driving battery 31, a battery remaining amount, an estimated operable time, a hydraulic oil thermometer, a traveling speed gear monitor, an electric system warning monitor, a motor output, and the like. These pieces of operation information can be acquired from the controller 60.

In a case where the excavator 1 is in the normal charging mode or the quick charging mode, the display unit 51 displays charging information which is information displayed on the monitor during charging. The charging information is, for example, a battery remaining amount, an elapsed time or a remaining time related to charging, information indicating that the normal charging or the quick charging is being performed, information indicating the progress of the charging, and the like. The charging information can be acquired from the controller 60. In addition, the operator can display and check detailed information, for example, the voltage, temperature, current, or the like of the driving battery 31 by operating the operation unit 52.

Note that the case of the normal charging mode or the quick charging mode may include not only the actual charging time but also the time during which the normal charging connector 102c or the quick charging connector 113c is connected to the charging inlet. In addition, it may also include a time from when the normal charging connector 102c or the quick charging connector 113c is removed from the charging inlet and the charging is finished until shutdown. That is, it may also include the entire time except that the operator operates the working equipment 5 or the like of the excavator 1 to work.

The display unit 51 includes an indicator lamp 51a for notifying the state of the normal charging system, an indicator lamp 51b for notifying the state of the quick charging system, and an indicator lamp 51c for notifying the state of the electric motor 32 in the upper part of the display screen. The indicator lamp 51a, the indicator lamp 51b, and the indicator lamp 51c are, for example, light emitting diodes (LEDs). The display unit controller 53 controls lighting and non-lighting of the indicator lamp 51a, the indicator lamp 51b, and the indicator lamp 51c. For example, the indicator lamp 51a notifies whether or not the normal charging can be performed by changing the color of light emission. The indicator lamp 51a displays a charging availability indication indicating the presence or absence of abnormality of the charging system of the normal charging system. For example, the indicator lamp 51b notifies whether or not the quick charging can be performed by changing the color of light emission. The indicator lamp 51b displays a charging availability indication indicating the presence or absence of abnormality of the charging system of the quick charging system. For example, the indicator lamp 51c notifies whether or not the electric motor 32 is operable by changing the color of light emission. The indicator lamp 51c displays an operation availability indication indicating whether the electric motor 32 can perform work or traveling. In addition, when there is no abnormality in each charging system or when the electric motor 32 is operable, the indicator lamp 51a, the indicator lamp 51b, and the indicator lamp 51c may not be turned on, and when there is an abnormality in charging of each charging system or when the electric motor 32 is not operable, the indicator lamp 51a, the indicator lamp 51b, and the indicator lamp 51c may be turned on. Alternatively, it may be reversed.

The operation unit 52 is, for example, a touch panel disposed on the lower side and the right side of the display unit 51 and disposed to overlap the liquid crystal display.

The display unit 51 and the operation unit 52 are connected to the display unit controller 53. When detecting an operation on the operation unit 52, the display unit controller 53 performs control to acquire operation information and output the operation information to the controller 60. When the excavator 1 is in the operation mode, the display unit controller 53 performs control to display the operation information acquired via the controller 60 on the display unit 51. When the excavator 1 is in the normal charging mode or the quick charging mode, the display unit controller 53 performs control to display the charging information acquired from the controller 60 on the display unit 51.

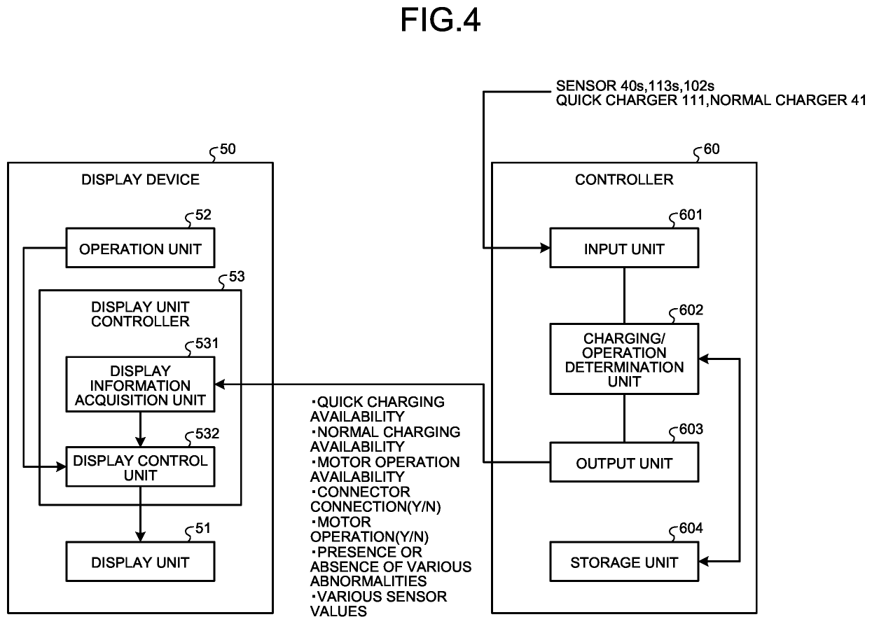

FIG. 4 is a block diagram illustrating a work vehicle display control device of the work vehicle. The work vehicle display control device includes the display unit controller 53 and the controller 60 (more specifically, the charging/operation determination unit 602).

The display unit controller 53 performs control to change the display according to the presence or absence of abnormality of the charging system and the determination result of the availability of work or traveling notified from the operation unit 52 and the controller 60. The display unit controller 53 includes a display information acquisition unit 531 and a display control unit 532.

The controller 60 (more specifically, the charging/operation determination unit 602) implements functions as a detection unit that detects abnormality for each charging system and a determination unit that determines the availability of work or traveling. In other words, although not illustrated, the charging/operation determination unit 602 includes a detection unit that detects abnormality for each charging system and a determination unit that determines the availability of work or traveling.

The controller 60 (more specifically, the charging/operation determination unit 602) determines the availability of the charging of the charging system based on the charging information for each charging system.

The controller 60 (more specifically, the charging/operation determination unit 602) determines the availability of the charging of the quick charging system based on the information on the quick charging system including the information from the sensor 40s, the sensor 113s, the quick charger 111, and the like received via the input unit 601. The controller 60 determines the availability of the charging of the normal charging system based on the information on the normal charging system including the information from the sensor 40s, the sensor 102s, and the normal charger 41 received via the input unit 601.

The availability of the charging of the quick charging system assumes that the quick charging system cannot perform the quick charging when the information on the quick charging system indicates that an abnormality that hinders the quick charging has occurred. For example, in a case where at least one of the temperature, the voltage, and the current of the quick charging system is out of an allowable range in the quick charging mode, it is assumed that an abnormality that hinders the quick charging has occurred. In a case where the information on the quick charging system indicates that an abnormality that hinders the quick charging is not occurring, the quick charging system can perform the quick charging. When the occurrence of the abnormality is eliminated after the abnormality that hinders the quick charging occurs, it is detected that the abnormality that hinders the quick charging is not occurring (eliminated).

The availability of the charging of the normal charging system assumes that the normal charging system cannot perform the normal charging when the information on the normal charging system indicates that an abnormality that hinders the normal charging has occurred. For example, in a case where at least one of the temperature, the voltage, and the current of the normal charging system is out of an allowable range in the normal charging mode, it is assumed that an abnormality that hinders the normal charging has occurred. In a case where the information on the normal charging system indicates that an abnormality that hinders the normal charging is not occurring, the normal charging system can perform the normal charging. When the occurrence of the abnormality is eliminated after the abnormality that hinders the normal charging occurs, it is detected that the abnormality that hinders the normal charging is not occurring (eliminated).

The determination result of the controller 60 (more specifically, the charging/operation determination unit 602) may be determined only in the normal charging mode or the quick charging mode, and may not be determined in the operation mode. For example, abnormality of the normal charging contactor that is used only in the normal charging mode may be detectable only in the normal charging mode, and may not be detectable in the quick charging mode and the operation mode. Therefore, the controller 60 (more specifically, the charging/operation determination unit 602) may store the determination result in the storage unit 604 in order to reliably transmit the information on the abnormality that can be detected only in the normal charging mode or the quick charging mode in which the operator is often unattended to the operator in the operation mode.

The charging/operation determination unit 602 determines the availability of work or traveling of the excavator 1 based on the battery information and the information on the discharge system acquired by the controller 60. The charging/operation determination unit 602 determines the availability of the operation of the electric motor 32 based on the battery information and the information on the discharge system acquired by the controller 60. The charging/operation determination unit 602 determines the availability of the operation of the electric motor 32 based on at least one of the temperature, the voltage, and the current of the driving battery 31, and the temperature, the voltage, and the current of the discharge system. Whether the normal charging connector 102c is connected to the normal charging inlet 102i or whether the quick charging connector 113c is connected to the quick charging inlet 113i may be used as the information on the discharge system. That is, the availability of the operation of the electric motor 32 may be determined based on information on whether or not the normal charging connector 102c is connected to the normal charging inlet 102i or information on whether or not the quick charging connector 113c is connected to the quick charging inlet 113i. The charging/operation determination unit 602 may store the determination result in the storage unit 604.

The availability of work or traveling of the excavator 1 is determined by availability of the operation of the electric motor 32. When the electric motor 32 cannot be operated, the excavator 1 cannot work or travel. The case where the electric motor 32 cannot be operated is a case where it is not allowable to operate the electric motor for safety, such as a case where there is an abnormality of the driving battery 31, an abnormality of a high-voltage circuit including an operation failure of a contactor, or an abnormality in an input of a working equipment lever even if the electric motor 32 is physically operable. For example, it is assumed that the electric motor 32 cannot be operated when at least one of the battery information, the charging information, and the discharge information is out of the allowable range in the operation mode. When the cause is eliminated after it is determined that the electric motor 32 cannot be operated, it is determined that the electric motor 32 can be operated (the cause is eliminated).

The output unit 603 outputs the determination result of the charging/operation determination unit 602 to the display information acquisition unit 531 of the display device 50.

The display information acquisition unit 531 acquires the determination result of the charging/operation determination unit 602 from the controller 60. The display information acquisition unit 531 may further acquire information on whether or not the charging cable is connected to the plurality of high-voltage charging systems from the controller 60.

Based on the determination result of the controller 60 acquired by the display information acquisition unit 531, the display control unit 532 varies the display according to the presence or absence of abnormality of the charging system and the availability of work or traveling. The display control unit 532 varies the charging availability indication for each charging system according to the availability of the charging of the charging system. More specifically, based on the determination result of the charging/operation determination unit 602 acquired by the display information acquisition unit 531, the display control unit 532 varies the indicator lamp 51a and the indicator lamp 51b as the charging availability indication depending on the presence or absence of abnormality of the charging system. In addition, the display control unit 532 varies the indicator lamp 51c, which is the operation availability indication, according to the availability of the operation of the electric motor 32 based on the determination result of the charging/operation determination unit 602 acquired by the display information acquisition unit 531.

The display control unit 532 changes and displays the lighting state, which is the display mode of the indicator lamp 51a, between the case where there is a hindrance to the charging of the normal charging system and the case where there is no hinderance. When there is a hindrance to the charging of the normal charging system, for example, the display control unit 532 lights the indicator lamp 51a in red to display that the normal charging cannot be performed. When there is no hindrance to the charging of the normal charging system, for example, the display control unit 532 lights the indicator lamp 51a in green to display that the normal charging can be performed.

The display control unit 532 changes and displays the lighting state, which is the display mode of the indicator lamp 51b, between the case where there is a hindrance to the charging of the quick charging system and the case where there is no hinderance. In a case where there is a hindrance to the charging of the quick charging system, for example, the display control unit 532 lights the indicator lamp 51b in red to display that the quick charging cannot be performed. In a case where there is no hindrance to the charging of the quick charging system, for example, the display control unit 532 lights the indicator lamp 51b in green to display that the quick charging can be performed.

The display control unit 532 may varies the charging availability indication for each charging system according to the availability of the charging of the charging system and the connection state.

The display control unit 532 changes and displays the lighting state, which is the display mode of the indicator lamp 51c, between the case where the operation of the electric motor 32 can be performed and the case where it cannot be performed. When the operation of the electric motor 32 cannot be performed, for example, the display control unit 532 lights the indicator lamp 51c in red to display that the operation cannot be performed. When the operation of the electric motor 32 can be performed, for example, the display control unit 532 lights the indicator lamp 51c in green to display that the operation can be performed.

The display control unit 532 may varies the operation availability indication according to the availability of the operation of the electric motor 32 and the operation state. In a case where the operation of the electric motor 32 cannot be performed, for example, in a case where the indicator lamp 51c is turned on in red to indicate that the operation cannot be performed, and the operation of the electric motor 32 can be performed, for example, the indicator lamp 51c is turned on in green to indicate that the operation can be performed, and further in a case where the electric motor 32 is operating, for example, the indicator lamp 51c is blinked in green to indicate that the operation is being performed. Alternatively, in a case where the operation of the electric motor 32 cannot be performed, for example, in a case where the indicator lamp 51c is turned on in red to indicate that the operation cannot be performed, and the operation of the electric motor 32 can be performed, for example, the indicator lamp 51c is not turned on to indicate that there is no abnormality (the operation can be performed), and further in a case where the electric motor 32 is operating, for example, the indicator lamp 51c is turned on in green to indicate that the operation is being performed. Note that the display by the indicator lamp 51c is an example and is not limited.

The display control unit 532 displays the availability of the charging for each charging system and the availability of work or traveling based on the acquisition result of the display information acquisition unit 531.

[Processing in Display Device]

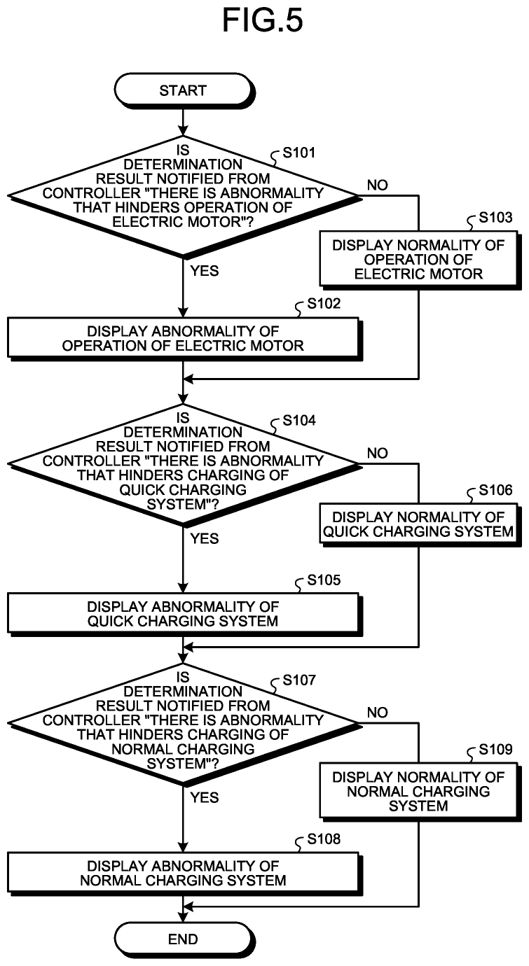

Processing by the display unit controller 53 of the display device 50 in the excavator 1 will be described. FIG. 5 is a flowchart illustrating a processing procedure of the display unit controller 53. In a case where the excavator 1 is in the operation mode, the processing illustrated in FIG. 5 is performed.

Based on the acquisition result of the display information acquisition unit 531, the display unit controller 53 determines to switch the display as to whether or not there is an abnormality that hinders the operation of the electric motor 32 (step S101). More specifically, when the determination result notified from the controller 60 is “there is an abnormality that hinders the operation of the electric motor 32” (Yes in step S101), the display unit controller 53 proceeds to step S102. When the determination result notified from the controller 60 is “there is no abnormality that hinders the operation of the electric motor 32” (No in step S101), the display unit controller 53 proceeds to step S103.

When the determination result notified from the controller 60 is “there is an abnormality that hinders the operation of the electric motor 32” (Yes in step S101), the display unit controller 53 causes the display control unit 532 to display that there is a hindrance to the operation of the electric motor 32 (step S102). More specifically, the display control unit 532 turns on the indicator lamp 51c in red to display that the operation cannot be performed. The operator can confirm that the electric motor 32 cannot be operated by the lighting state of the indicator lamp 51c. The display unit controller 53 proceeds to step S104.

When the determination result notified from the controller 60 is “there is no abnormality that hinders the operation of the electric motor 32” (No in step S101), the display unit controller 53 causes the display control unit 532 to display that there is no hindrance to the operation of the electric motor 32 (step S103). More specifically, the display control unit 532 turns on the indicator lamp 51c in green to display that the operation can be performed. The operator can confirm that the electric motor 32 can be operated by the lighting state of the indicator lamp 51c. The display unit controller 53 proceeds to step S104.

Based on the acquisition result of the display information acquisition unit 531, the display unit controller 53 determines to switch the display as to whether or not there is an abnormality that hinders the charging of the quick charging system (step S104). More specifically, when the determination result notified from the controller 60 is “there is an abnormality that hinders the charging of the quick charging system” (Yes in step S104), the display unit controller 53 proceeds to step S105. When the determination result notified from the controller 60 is “there is no abnormality that hinders the charging of the quick charging system” (No in step S104), the display unit controller 53 proceeds to step S106.

When the determination result notified from the controller 60 is “there is an abnormality that hinders the charging of the quick charging system” (Yes in step S104), the display unit controller 53 causes the display control unit 532 to display that there is a hindrance to the charging of the quick charging system (step S105). More specifically, the display control unit 532 turns on the indicator lamp 51b in red to display that the quick charging cannot be performed. The operator can confirm that the quick charging cannot be performed by the lighting state of the indicator lamp 51b. The display unit controller 53 proceeds to step S107.

When the determination result notified from the controller 60 is “there is no abnormality that hinders the charging of the quick charging system” (No in step S104), the display unit controller 53 causes the display control unit 532 to display that there is no hindrance to the charging of the quick charging system (step S106). More specifically, the display control unit 532 turns on the indicator lamp 51b in green to display that the quick charging can be performed. The operator can confirm that the quick charging can be performed by the lighting state of the indicator lamp 51b. The display unit controller 53 proceeds to step S107.

Based on the acquisition result of the display information acquisition unit 531, the display unit controller 53 determines to switch the display as to whether or not there is an abnormality that hinders the charging of the normal charging system (step S107). More specifically, when the determination result notified from the controller 60 is “there is an abnormality that hinders the charging of the normal charging system” (Yes in step S107), the display unit controller 53 proceeds to step S108. When the determination result notified from the controller 60 is “there is no abnormality that hinders the charging of the normal charging system” (No in step S107), the display unit controller 53 proceeds to step S109.

When the determination result notified from the controller 60 is “there is an abnormality that hinders the charging of the normal charging system” (Yes in step S107), the display unit controller 53 causes the display control unit 532 to display that there is a hindrance to the charging of the normal charging system (step S108). More specifically, the display control unit 532 turns on the indicator lamp 51a in red to display that the normal charging cannot be performed. The operator can confirm that the normal charging cannot be performed by the lighting state of the indicator lamp 51a. The display unit controller 53 ends the process.

When the determination result notified from the controller 60 is “there is no abnormality that hinders the charging of the normal charging system” (No in step S107), the display unit controller 53 causes the display control unit 532 to display that there is no hindrance to the charging of the normal charging system (step S109). More specifically, the display control unit 532 turns on the indicator lamp 51a in green to display that the normal charging can be performed. The operator can confirm that the normal charging can be performed by the lighting state of the indicator lamp 51a. The display unit controller 53 ends the process.

[Computer System]

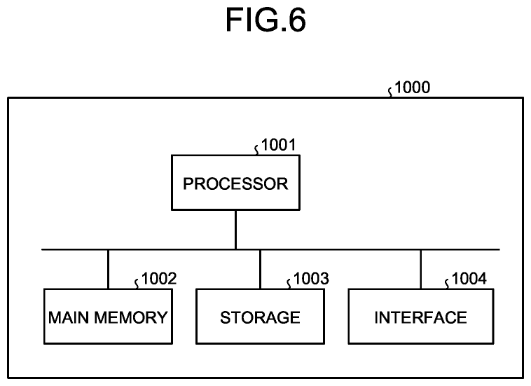

FIG. 6 is a block diagram illustrating a computer system 1000 according to the present embodiment. The above-described controller 60 includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The above-described functions of the controller 60 are stored in the storage 1003 as a program. The processor 1001 reads the program from the storage 1003, develops the program in the main memory 1002, and executes the above-described processing according to the program. Note that the program may be distributed to the computer system 1000 via a network.

As described above, the excavator 1 performs display different from a normal display for each charging system such that it is possible to determine which charging system among the plurality of high-voltage charging systems has the abnormality. The excavator 1 performs display different between the case where work or traveling can be performed and the case where work or traveling cannot be performed such that it is possible to determine the availability of work or traveling.

[Effects]

In the present embodiment, the presence or absence of abnormality that hinders the charging is detected for each charging system. According to the present embodiment, the display device 50 can display the availability of the charging for each charging system. In the present embodiment, the display device 50 can perform display of the charging system that hinders the charging different from a normal display. According to the present embodiment, the operator can appropriately confirm which charging system among the plurality of high-voltage charging systems has an abnormality that hinders the charging. According to the present embodiment, the operator can charge the excavator 1 using the charging system in which the abnormality that hinders the charging is not occurring among the plurality of high-voltage charging systems.

In the present embodiment, the display device 50 can perform display different between the case where work or traveling can be performed and the case where work or traveling cannot be performed, or the like. According to the present embodiment, the operator can easily determine whether or not work or traveling can be performed by checking the display on the display device 50.

As described above, in the present embodiment, when an abnormality occurs in one of the plurality of high-voltage charging systems, it is possible to confirm whether or not there is an abnormality in other charging systems and the availability of work or traveling of the excavator 1. In the present embodiment, the operator can appropriately confirm the influence range of the failure. According to the present embodiment, for example, the excavator 1 can be operated while being charged by a chargeable charging system. According to the present embodiment, for example, in a case where the excavator 1 can travel and the battery remaining amount of the driving battery 31 remains, the excavator 1 can be caused to travel to a position where it does not hinder the site work.

On the other hand, when an abnormality occurs in one charging system among the plurality of high-voltage charging systems, it is not possible to appropriately confirm the influence range of the failure of the excavator 1 in a case where it is not possible to confirm the presence or absence of an abnormality in other charging systems and the availability of work or traveling of the excavator 1. In such a case, there is a high possibility that the operator immediately stops the operation of the excavator 1 even if the excavator 1 can be actually charged by other charging systems or the excavator 1 can work or travel. In this way, when the excavator 1 is not moved from the site and stops operation, the excavator 1 is large and heavy, and thus larger equipment such as a crane vehicle and a truck is required to carry out the excavator 1 for repair. In addition, until the excavator 1 is carried out, the excavator 1 obstructs traffic of other vehicles and persons or obstructs other work at the work site, which causes a delay in the construction period. As described above, the work vehicle such as the excavator 1 affects work of a wide range of related persons when performing work on site, unlike an electric car or the like. When the excavator 1 is unnecessarily stopped, the work of a wide range of related persons is delayed, and the economic loss due to the delay in the construction period is also increased.

According to the present embodiment, when the excavator 1 is activated in the operation mode, it is possible to display the availability of the charging for each charging system and the availability of work or traveling based on the detection result and the determination result stored in the storage unit. In the operation mode, it is possible to confirm the availability of the charging for each charging system based on the detection result stored in the storage unit, and thus, it is possible to prevent a situation in which it is found that charging in the charging mode cannot be performed when charging is attempted after operating in the operation mode and decreasing the battery remaining amount, and there is no battery remaining amount for charging in other available charging systems.

<Modification 1>

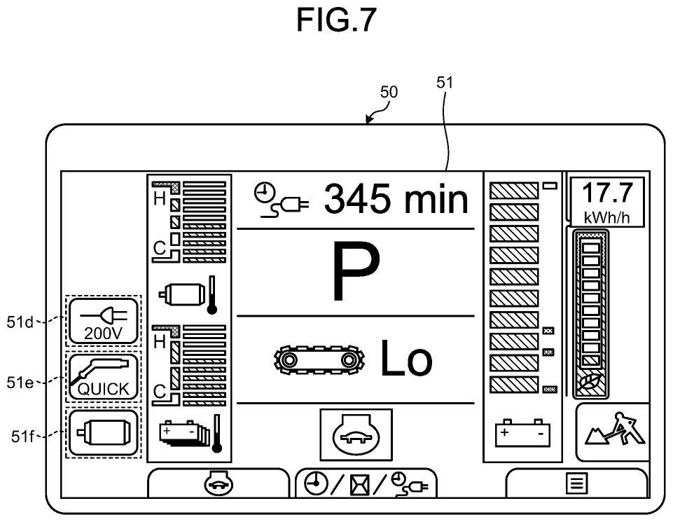

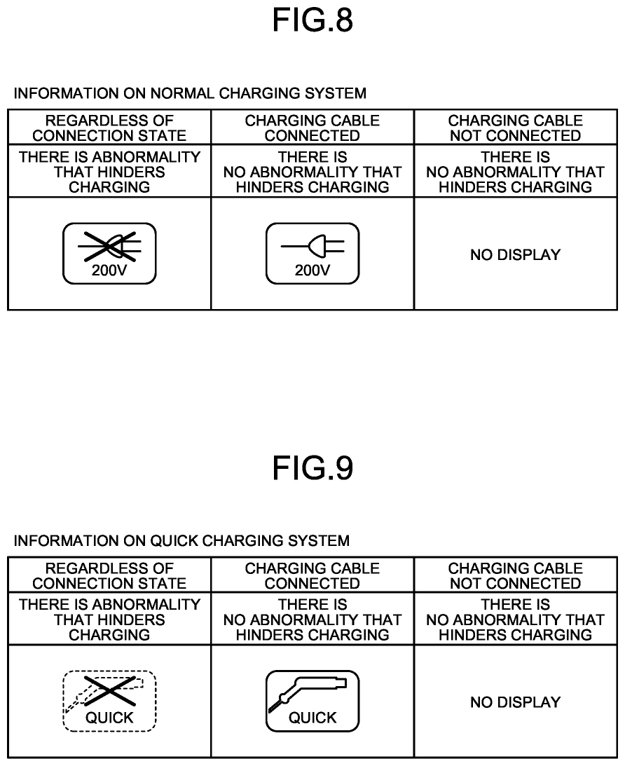

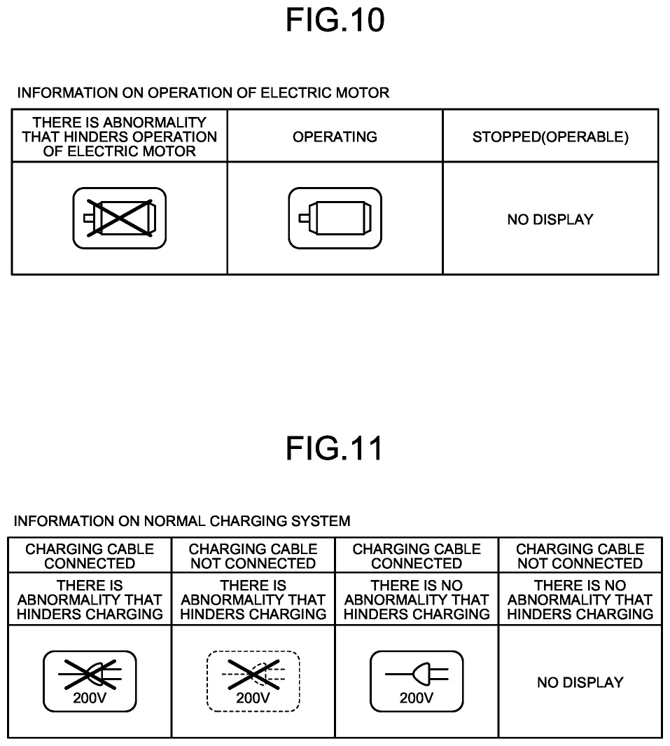

FIG. 7 is a schematic diagram illustrating another example of the display device 50 of the excavator 1. FIG. 8 is a diagram for describing an example of a display related to the normal charging system. FIG. 9 is a diagram for describing an example of a display related to the quick charging system. FIG. 10 is a diagram for describing an example of a display related to the operation of the electric motor 32. In the charging availability indication, the connection state of the charging cable to the charging connector is simultaneously displayed in addition to the display of the availability of the charging for each charging system.

The display unit 51 includes a display unit 51d that notifies the state of the normal charging system, a display unit 51e that notifies the state of the quick charging system, and a display unit 51f that notifies the state of the electric motor 32 on the left side of the display screen. The display of the display unit 51d, the display unit 51e, and the display unit 51f is controlled by the display unit controller 53. The display unit 51d displays the charging availability indication. For example, the display unit 51d displays whether or not the normal charging can be performed by changing the display mode of the normal charging icon. The display unit 51e displays the charging availability indication. For example, the display unit 51e displays whether or not the quick charging can be performed by changing the display mode of the quick charging icon. The display unit 51f displays the operation availability indication. For example, the display unit 51f displays whether or not the electric motor 32 is operable by changing the display mode of the electric motor icon.

An example of a change in the display mode of the normal charging icon will be described with reference to FIG. 8. The normal charging icon is, for example, an image obtained by superimposing a cross on an image imitating the normal charging connector in a state where there is an abnormality that hinders the charging. The normal charging icon is an image imitating the normal charging connector in a state where there is no abnormality that hinders the charging and the charging cable is connected. In a state where there is no abnormality that hinders the charging and the charging cable is not connected, the normal charging icon is not displayed.

An example of a change in the display mode of the quick charging icon will be described with reference to FIG. 9. The quick charging icon is, for example, an image obtained by superimposing a cross on an image imitating the quick charging connector in a state where there is an abnormality that hinders the charging. The quick charging icon is an image imitating the quick charging connector in a state where there is no abnormality that hinders the charging and the charging cable is connected. In a state where there is no abnormality that hinders the charging and the charging cable is not connected, the quick charging icon is not displayed.

An example of a change in the display mode of the electric motor icon will be described with reference to FIG. 10. The electric motor icon is, for example, an image obtained by superimposing a cross on an image imitating the electric motor 32 in a state where there is an abnormality that hinders the operation of the electric motor 32. The electric motor icon is an image imitating the electric motor 32 when there is no abnormality that hinders the operation of the electric motor 32 and the electric motor 32 is operating. When there is no abnormality that hinders the operation of the electric motor 32 and the electric motor 32 is stopped, the electric motor icon is not displayed.

<Modification 2>

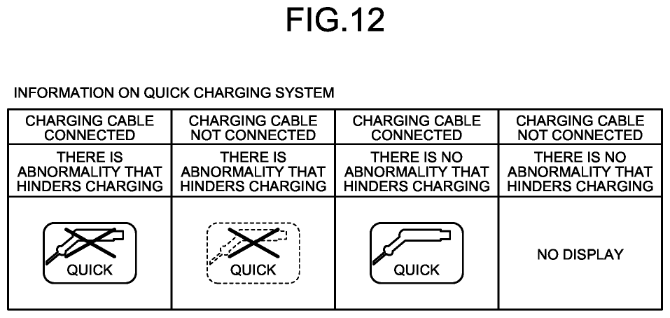

FIG. 11 is a diagram for describing another example of the display related to the normal charging system. FIG. 12 is a diagram for describing another example of the display related to the quick charging system. The display unit 51 is configured similarly to Modification 1.

An example of a change in the display mode of the normal charging icon will be described with reference to FIG. 11. The normal charging icon is, for example, an image obtained by superimposing a cross on an image imitating the normal charging connector in a state where there is an abnormality that hinders the charging and the charging cable is connected. The normal charging icon is, for example, an image obtained by superimposing a cross on an image in which the normal charging connector is displayed to be dimmed while characters indicating the normal charging are displayed in a state where there is an abnormality that hinders the charging and the charging cable is not connected. In a state where there is no abnormality that hinders the charging, the normal charging icon has a mode similar to that in FIG. 8 regardless of whether the charging cable is connected or not.

An example of a change in the display mode of the quick charging icon will be described with reference to FIG. 12. The quick charging icon is, for example, an image obtained by superimposing a cross on an image imitating the quick charging connector in a state where there is an abnormality that hinders the charging and the charging cable is connected. The quick charging icon is, for example, an image obtained by superimposing a cross on an image in which the quick charging connector is displayed to be dimmed while characters indicating the quick charging are displayed in a state where there is an abnormality that hinders the charging and the charging cable is not connected. In a state where there is no abnormality that hinders the charging, the quick charging icon has a mode similar to that in FIG. 9 regardless of whether the charging cable is connected or not.

<Modification 3>

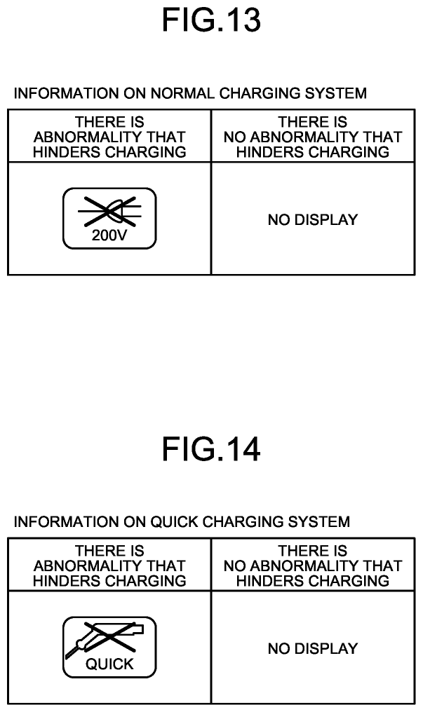

FIG. 13 is a diagram for describing another example of the display related to the normal charging system. FIG. 14 is a diagram for describing another example of the display related to the quick charging system. The display unit 51 is configured similarly to Modification 1.

An example of a change in the display mode of the normal charging icon will be described with reference to FIG. 13. The normal charging icon is, for example, an image obtained by superimposing a cross on an image imitating the normal charging connector in a state where there is an abnormality that hinders the charging. In a state where there is no abnormality that hinders the charging, the normal charging icon is not displayed.

An example of a change in the display mode of the quick charging icon will be described with reference to FIG. 14. The quick charging icon is, for example, an image obtained by superimposing a cross on an image imitating the quick charging connector in a state where there is an abnormality that hinders the charging. In a state where there is no abnormality that hinders the charging, the quick charging icon is not displayed.

<Other Modifications>

The excavator 1 is not limited to the canopy specification, and can also be applied to a cabin specification in which a cab having a window or a door is mounted.

In addition, in the above-described embodiments, the excavator 1 has been described as an example of the work vehicle, but the present embodiment may be applied to other work vehicles such as a medium-sized or large excavator, a wheel loader, and a bulldozer other than the excavator. Note that the work vehicle includes a traveling device and working equipment such as a bucket and a blade.

Note that, in the embodiment of charging, two types of charging methods, the normal charging and the quick charging, are described to be possible in the above description, but the present disclosure is not limited thereto. In the above description, the commercial power source is described to be single-phase 200 V in the normal charging and three-phase 200 V in the quick charging, but the present disclosure is not limited thereto.

In the above description, the display unit controller 53 and the controller 60 are described as separate units, but the present disclosure is not limited thereto. The display unit controller 53 and the controller 60 may be integrated.

Note that the work vehicle may be a work vehicle in which at least some of the working equipment, the traveling motor, and the swing motor are driven only by electric actuators without the hydraulic system. In this case, power is supplied from the driving battery 31 to the electric actuators. The work vehicle is an electric work vehicle.

### REFERENCE SIGNS LIST

1 EXCAVATOR (WORK VEHICLE)
2 LOWER TRAVELING BODY
3 UPPER SWING BODY
4 BLADE
5 WORKING EQUIPMENT
6 OPERATOR SEAT
7 WORKING EQUIPMENT LEVER
8 TRAVELING LEVER
11 PILLAR
12 ROOF
13 SUPPORT ARM
20 HYDRAULIC SYSTEM
21 MAIN PUMP
22 MAIN VALVE
23 TRAVELING MOTOR
24 TRAVELING MOTOR
25 SWING MOTOR
26 WORKING EQUIPMENT CYLINDER
31 DRIVING BATTERY
32 ELECTRIC MOTOR
33 INVERTER
34 KEY SWITCH
35 AUXILIARY BATTERY
40 POWER SUPPLY DISTRIBUTION UNIT
41 NORMAL CHARGER
50 DISPLAY DEVICE
51 DISPLAY UNIT
51a INDICATOR LAMP (CHARGING AVAILABILITY INDICATION)
51b INDICATOR LAMP (CHARGING AVAILABILITY INDICATION)
51c INDICATOR LAMP (OPERATION AVAILABILITY INDICATION)
52 OPERATION UNIT
53 DISPLAY UNIT CONTROLLER (WORK VEHICLE DISPLAY CONTROL DEVICE)
531 DISPLAY INFORMATION ACQUISITION UNIT
532 DISPLAY CONTROL UNIT
60 CONTROLLER (WORK VEHICLE DISPLAY CONTROL DEVICE)
601 INPUT UNIT
602 CHARGING/OPERATION DETERMINATION UNIT (DETECTION UNIT, DETERMINATION UNIT)
603 OUTPUT UNIT
604 STORAGE UNIT
111 QUICK CHARGER

1. A work vehicle display control device of a work vehicle including a plurality of high-voltage charging systems, at least one of working equipment and a traveling device being driven by a driving force of an electric motor, the work vehicle display control device comprising:
a detection unit that detects an abnormality for each of the charging systems;
a determination unit that determines availability of work or traveling of the work vehicle; and
a display control unit that varies a charging availability indication indicating presence or absence of the abnormality for each of the charging systems according to the presence or absence of the abnormality for each of the charging systems based on a detection result of the detection unit, and varies an operation availability indication indicating availability of work or traveling according to the availability of work or traveling based on a determination result of the determination unit.

2. The work vehicle display control device according to claim 1, wherein
the detection unit detects availability of charging for each of the charging systems based on at least one of a temperature, a voltage, and a current for each of the charging systems, and
the display control unit varies the charging availability indication according to the availability of the charging for each of the charging systems.

3. The work vehicle display control device according to claim 2, wherein
the detection unit detects whether or not a charging cable is connected to at least one of the charging systems, and
the display control unit varies the charging availability indication according to whether or not the charging cable is connected to at least one of the charging systems.

4. The work vehicle display control device according to claim 1, wherein
the detection unit stores the detection result detected during charging in a storage unit, and
the display control unit causes the charging availability indication to be displayed when the work vehicle is in operation.

5. The work vehicle display control device according to claim 1, wherein
the determination unit determines availability of an operation of the electric motor based on at least one of a temperature, a voltage, and a current of a battery, and presence or absence of abnormality, a temperature, a voltage, and a current of a discharge system, and
the display control unit varies the operation availability indication according to the availability of the operation of the electric motor.

6. A work vehicle comprising:
a display unit of a work vehicle that is rechargeable; and
the work vehicle display control device according to claim 1.
